(19) United States
(12) Patent Application Publication
(10) Pub. No.: US 2022/0385897 A1
(43) Pub. Date: Dec. 1, 2022

(54) ADAPTIVE INTERPOLATION FILTER FOR MOTION COMPENSATION

(71) Applicant: VID SCALE, INC., Wilmington, DE (US)

(72) Inventors: Wei Chen, San Diego, CA (US); Yuwen He, San Diego, CA (US); Hua Yang, Plainsboro, NJ (US)

(73) Assignee: VID SCALE, INC., Wilmington, DE (US)

(21) Appl. No.: 17/761,254

(22) PCT Filed: Sep. 18, 2020
(86) PCT No.: PCT/US2020/051614

§ 371 Date: Mar. 17, 2022

Related U.S. Application Data
(60) Provisional application No. 62/902,089, filed on Sep. 18, 2019.
(60) Provisional application No. 62/904,523, filed on Sep. 23, 2019.
(60) Provisional application No. 62/905,867, filed on Sep. 25, 2019.

(51) Int. Cl. H04N 19/117; H04N 19/80; H04N 19/105; H04N 19/132; H04N 19/176

(52) U.S. Cl. CPC H04N 19/117; H04N 19/80; H04N 19/105; H04N 19/132; H04N 19/176

(57) ABSTRACT

A video processing apparatus may comprise one or more processors that are configured to determine an interpolation filter length for an interpolation filter associated with a coding unit (CU) based on a size of the CU. The one or more processor may be configured to determine an interpolated reference sample based on the determined interpolation filter length for the interpolation filter and a reference sample for the CU. The one or more processor may be configured to predict the CU based on the interpolated reference sample. For example, if a first CU has a size that is greater than the size of a second CU, the one or more processors may be configured to use a shorter interpolation filter for the first CU than for the second CU.

### CROSS-REFERENCE TO RELATED APPLICATIONS

This application claims the benefit of Provisional U.S. Patent Application No. 62/902,089, filed Sep. 18, 2019, Provisional U.S. Patent Application No. 62/904,523, filed Sep. 23, 2019, Provisional U.S. Patent Application No. 62/905,867, filed Sep. 25, 2019, the disclosures of which are incorporated herein by reference in their entireties.

### BACKGROUND

Video coding systems may be used to compress digital video signals, for example, to reduce the storage and/or transmission bandwidth associated with such signals. Video coding systems may include block-based, wavelet-based, and/or object-based systems. A block-based hybrid video coding system may be deployed.

### SUMMARY

Systems, methods, and instrumentalities are disclosed for applying adaptive interpolation filtering during motion compensation. A video processing apparatus as described herein may comprise one or more processors that are configured to determine an interpolation filter length for an interpolation filter associated with a coding unit (CU) based on a size of the CU, determine an interpolated reference sample based on the determined interpolation filter length for the interpolation filter and a reference sample for the CU, and predict the CU based on the interpolated reference sample. For example, if a first CU has a size that is greater than the size of a second CU, the one or more processors may use a shorter interpolation filter for the first CU than for the second CU. In addition, the one or more processors of the video processing apparatus may also be configured to select a motion vector (MV) for the CU from a plurality of MV candidates for the CU, determine a MV associated with the reference sample based on the MV for the CU, determine the reference sample based on the MV associated with the reference sample, and perform an interpolation using the reference sample and the interpolation filter that has the determined interpolation filter length to determine the interpolated reference sample.

A video processing apparatus as described herein may comprise one or more processors that are configured to determine a size of a CU and a reference sample for the CU; determine whether to apply an interpolation filter on the reference sample for the CU based on the size of the CU; and predict the CU based on the determination of whether to apply the interpolation filter on the reference sample for the CU. The video processing apparatus as described herein may comprise one or more processors that are configured to determine that an interpolation filter length for the interpolation filter is one based on the size of the CU and skip interpolation on the reference sample based on the determination that the interpolation filter length for the interpolation filter is one such that the CU is predicted using the reference sample (for example, without interpolation) for the CU.

The CU described herein may be an affine mode CU and may comprise one or more 4×4 sub-blocks. The one or more processors of the video processing apparatus may be further configured to determine a motion vector (MV) for a 4×4 sub-block in the CU based on at least a MV associated with the CU and predict the CU based on the determined MV for the 4×4 sub-block of the CU. The length of an interpolation filter as described herein may be indicated by the number of taps associated with the filter. The interpolation filter may be used to determine the value of a reference sample located at a fractional pixel position.

### BRIEF DESCRIPTION OF THE DRAWINGS

FIG. 1A is a system diagram illustrating an example communications system.

FIG. 1B is a system diagram illustrating an example wireless transmit/receive unit (WTRU) that may be used within the communications system illustrated in FIG. 1A.

FIG. 1C is a system diagram illustrating an example radio access network (RAN) and an example core network (CN) that may be used within the communications system illustrated in FIG. 1A.

FIG. 1D is a system diagram illustrating a further example RAN and a further example CN that may be used within the communications system illustrated in FIG. 1A.

FIG. 2 illustrates an example video encoder.

FIG. 3 illustrates an example video decoder.

FIG. 4 illustrates a block diagram of an example of a system in which various aspects and examples are implemented.

FIG. 5 shows example top and left neighboring blocks that may be used in combined inter and intra prediction (CIIP) weight derivation.

FIG. 6 shows an example triangle partitioning based inter prediction.

FIG. 7 shows an example of uni-prediction motion vector selection for a triangle partition mode (TPM).

FIG. 8 shows example weights that may be used in blending, for example, for TPM.

FIG. 9 shows an example of using different interpolation filters for sub-blocks inside a TPM edge area and sub-blocks outside of the TPM edge area.

FIG. 10 shows an example of adaptive interpolation filters for samples associated with different weights (for example, in a TPM mode).

FIG. 11 illustrates an example method of performing adaptive interpolation based on a CU size.

FIG. 12 illustrates an example CIIP mode that uses a planar intra prediction mode and an interprediction mode (for example, a nearest integer MV).

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

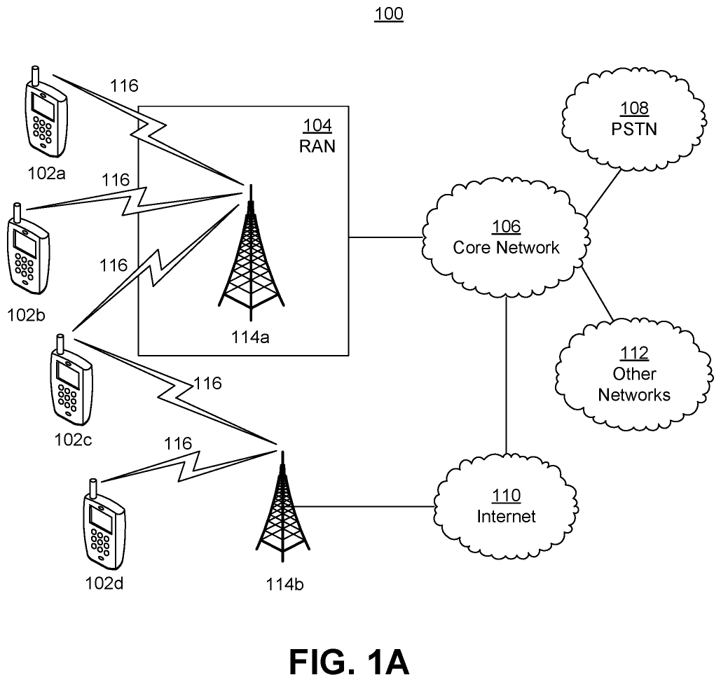

FIG. 1A is a diagram illustrating an example communications system 100 in which one or more disclosed examples may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed examples may contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an example, the base station 114a may include three transceivers, i.e., one for each sector of the cell. In an example, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an example, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an example, the base station 114a and the WTRUs 102a, 102b, 102c may implement a radio technology such as NR Radio Access, which may establish the air interface 116 using New Radio (NR).

In an example, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In examples, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an example, the base station 114b and the WTRUs 102c, 102d may implement a radio technology such as IEEE 802.11 to establish a wireless local area network (WLAN). In an example, the base station 114b and the WTRUs 102c, 102d may implement a radio technology such as IEEE 802.15 to establish a wireless personal area network (WPAN). In an example, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in an example, the transmit/receive element 122 may be an antenna configured to transmit and/or receive RF signals. In an example, the transmit/receive element 122 may be an emitter/detector configured to transmit and/or receive IR, UV, or visible light signals, for example. In an example, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in an example, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In examples, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an example, the WRTU 102 may include a half-duplex radio for which transmission and reception of some or all of the signals (e.g., associated with particular subframes for either the UL (e.g., for transmission) or the downlink (e.g., for reception)).

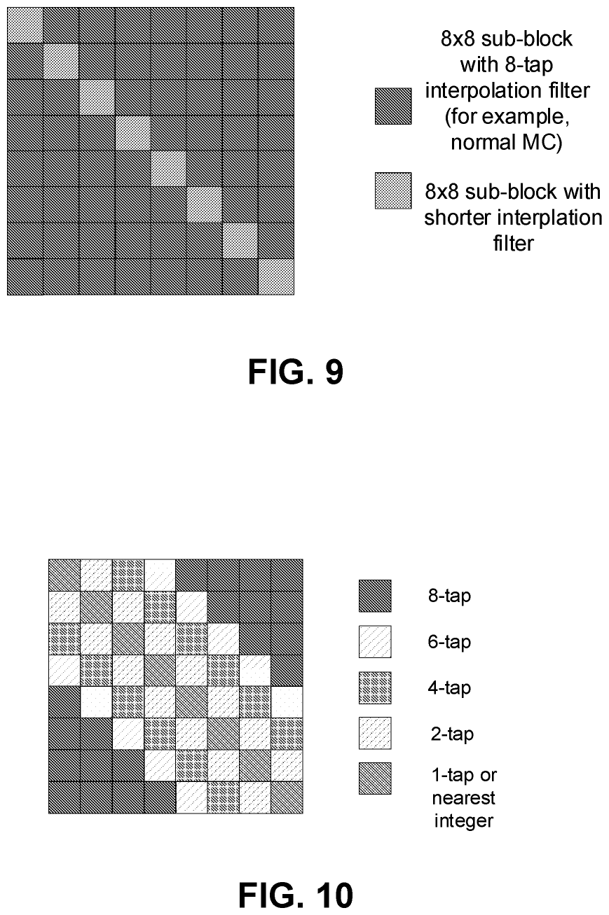

FIG. 10 is a system diagram illustrating an example RAN 104 and the CN 106. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs. The eNode-Bs 160a, 160b, 160c may each include one or more transceivers for communicating with the WTRUs 102a, 102b, 102c over the air interface 116. In an example, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain examples such a terminal may use (e.g., temporarily or permanently) wired communication interfaces with the communication network.

In examples, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In examples, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In examples, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to an example, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating an example RAN 113 and the CN 115. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs. The gNBs 180a, 180b, 180c may each include one or more transceivers for communicating with the WTRUs 102a, 102b, 102c over the air interface 116. In an example, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an example, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an example, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an example, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

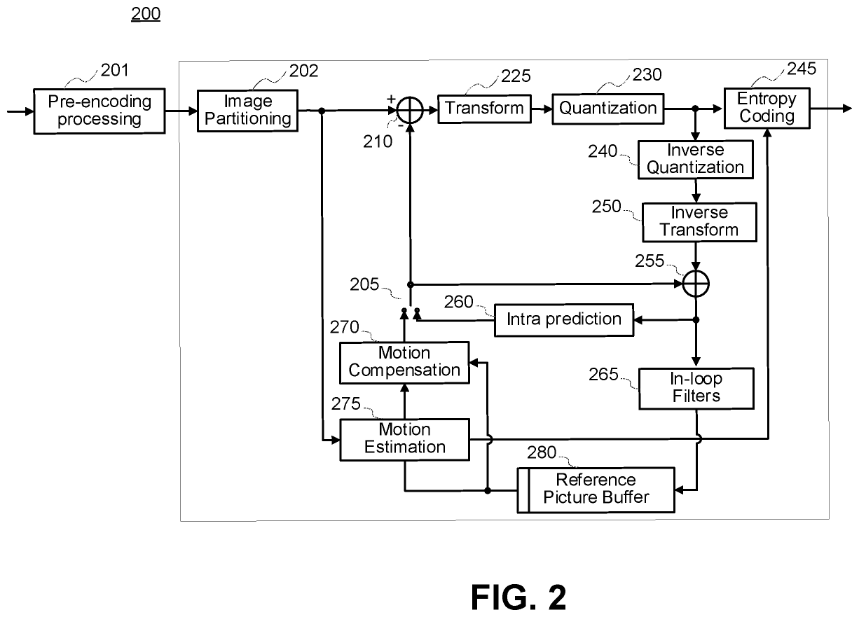

The aspects described and contemplated in this application can be implemented in many different forms. FIGS. 5-12 described herein may provide some examples, but other examples are contemplated and the discussion of FIGS. 5-12 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

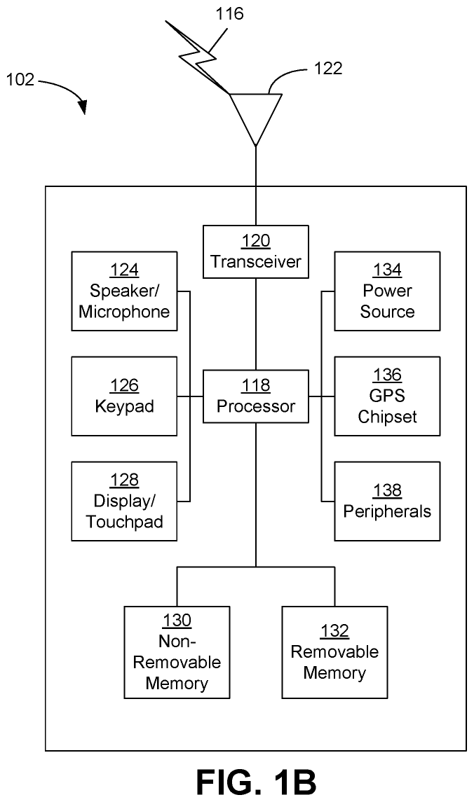

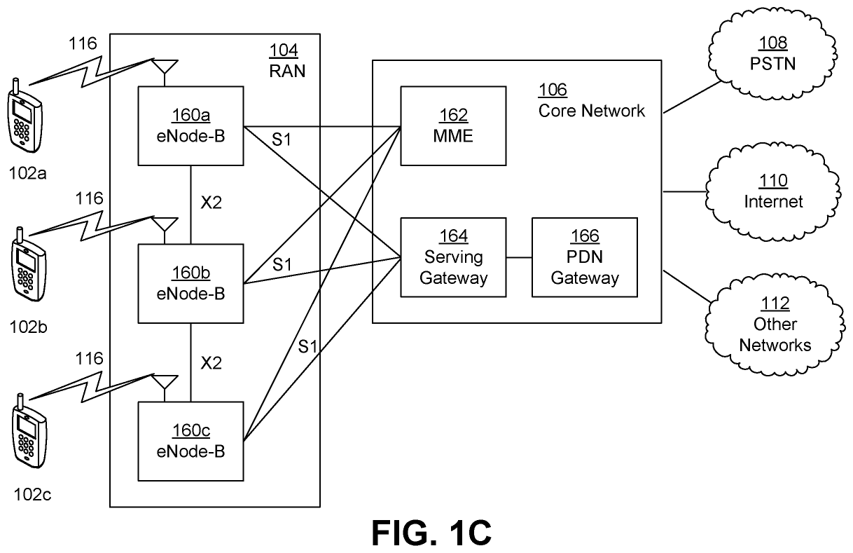

Various methods and other aspects described in this application can be used to modify modules, for example, decoding modules, of a video encoder 200 and decoder 300 as shown in FIG. 2 and FIG. 3. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application, for example, a filter being a 2-tap filter, a 4-tap filter, a 6-tap filter or a 8-tap filter, a sub-block having a size of 4×4, the largest CU size for inter prediction being at most 128 in width and/or height, etc. The specific values are for example purposes and the aspects described are not limited to these specific values.

FIG. 2 illustrates an encoder 200. Variations of this encoder 200 are contemplated, but the encoder 200 is described below for purposes of clarity without describing all expected variations.

Before being encoded, the video sequence may go through pre-encoding processing (201), for example, applying a color transform to the input color picture (for example, conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 illustrates a block diagram of a video decoder 300. In example decoder 300, a bitstream is decoded by the decoder elements as described below. Video decoder 300 generally performs a decoding pass reciprocal to the encoding pass as described in FIG. 2. The encoder 200 may also generally perform video decoding as part of encoding video data. For example, the encoder 200 may perform one or more of the video decoding steps presented herein. The encoder reconstructs the decoded images, for example, to maintain synchronization with the decoder with respect to one or more of the following: reference pictures, entropy coding contexts, and other decoder-relevant state variables.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (for example conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

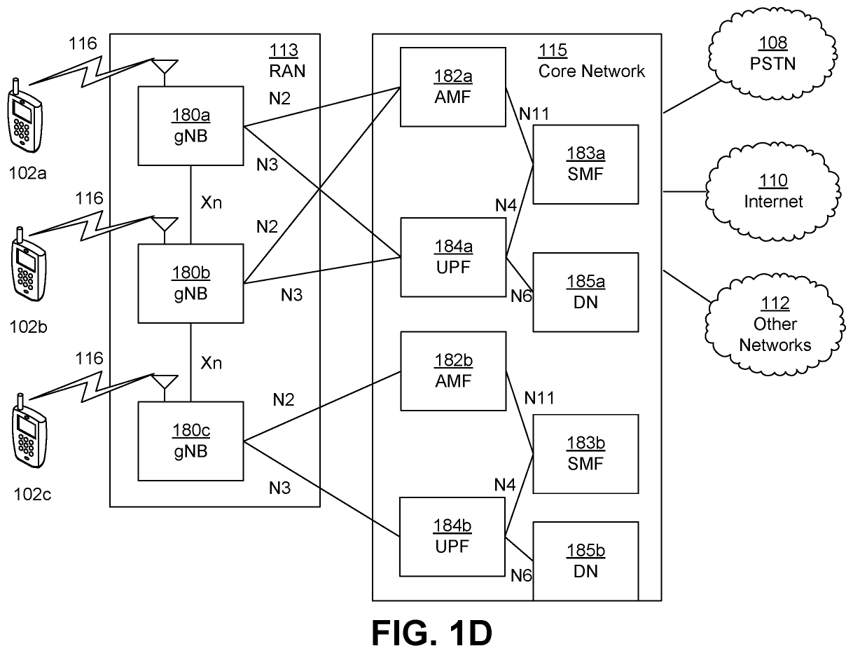

FIG. 4 illustrates a block diagram of an example of a system in which various aspects and examples are implemented. System 400 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, can be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (for example, a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that can be included in a device to perform the encoding and/or decoding functions. As is known, a device can include one or both of the encoding and decoding modules. Additionally, encoder/decoder module 430 can be implemented as a separate element of system 400 or can be incorporated within processor 410 as a combination of hardware and software as known to those skilled in the art.

Program code to be loaded onto processor 410 or encoder/decoder 430 to perform the various aspects described in this document can be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device can be either the processor 410 or the encoder/decoder module 430) is used for one or more of these functions. The external memory can be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 400 can be provided through various input devices as indicated in block 4430. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 4430 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain examples, (iv) demodulating the downconverted and band-limited signal, (v) performing error correction, and (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

Additionally, the USB and/or HDMI terminals can include respective interface processors for connecting system 400 to other electronic devices across USB and/or HDMI connections. It is to be understood that various aspects of input processing, for example, Reed-Solomon error correction, can be implemented, for example, within a separate input processing IC or within processor 410 as necessary. Similarly, aspects of USB or HDMI interface processing can be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 can be provided within an integrated housing, Within the integrated housing, the various elements can be interconnected and transmit data therebetween using suitable connection arrangement 4440, for example, an internal bus as known in the art, including the Inter-IC (I2C) bus, wiring, and printed circuit boards.

The system 400 includes communication interface 450 that enables communication with other devices via communications channel 460. The communication interface 450 can include, but is not limited to, a transceiver configured to transmit and to receive data over communications channel 460. The communication interface 450 can include, but is not limited to, a modem or network card and the communication channel 460 can be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 4430. Still other examples provide streamed data to the system 400 using the RF connection of the input block 4430. As indicated above, various examples provide data in a non-streaming manner. Additionally, various examples use wireless networks other than Wi-Fi, for example a cellular network or a Bluetooth network.

The system 400 can provide an output signal to various output devices, including a display 4400, speakers 4410, and other peripheral devices 4420. The display 4400 of various examples includes one or more of, for example, a touchscreen display, an organic light-emitting diode (OLED) display, a curved display, and/or a foldable display. The display 4400 can be for a television, a tablet, a laptop, a cell phone (mobile phone), or other device. The display 4400 can also be integrated with other components (for example, as in a smart phone), or separate (for example, an external monitor for a laptop). The other peripheral devices 4420 include, in various examples of examples, one or more of a stand-alone digital video disc (or digital versatile disc) (DVR, for both terms), a disk player, a stereo system, and/or a lighting system. Various examples use one or more peripheral devices 4420 that provide a function based on the output of the system 400. For example, a disk player performs the function of playing the output of the system 400.

In various examples, control signals are communicated between the system 400 and the display 4400, speakers 4410, or other peripheral devices 4420 using signaling such as AV.Link, Consumer Electronics Control (CEC), or other communications protocols that enable device-to-device control with or without user intervention. The output devices can be communicatively coupled to system 400 via dedicated connections through respective interfaces 470, 480, and 490. Alternatively, the output devices can be connected to system 400 using the communications channel 460 via the communications interface 450. The display 4400 and speakers 4410 can be integrated in a single unit with the other components of system 400 in an electronic device such as, for example, a television. In various examples, the display interface 470 includes a display driver, such as, for example, a timing controller (T Con) chip.

The display 4400 and speakers 4410 can alternatively be separate from one or more of the other components, for example, if the RF portion of input 4430 is part of a separate set-top box. In various examples in which the display 4400 and speakers 4410 are external components, the output signal can be provided via dedicated output connections, including, for example, HDMI ports, USB ports, or COMP outputs.

The examples can be carried out by computer software implemented by the processor 410 or by hardware, or by a combination of hardware and software. As a non-limiting example, the examples can be implemented by one or more integrated circuits. The memory 420 can be of any type appropriate to the technical environment and can be implemented using any appropriate data storage technology, such as optical memory devices, magnetic memory devices, semiconductor-based memory devices, fixed memory, and removable memory, as non-limiting examples. The processor 410 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, determining a size of a CU and a reference sample for the CU; determining whether to apply an interpolation filter on a reference sample for the CU based on a size of the CU; predicting a CU based on a determination of whether to apply an interpolation filter on a reference sample of a CU; determining an interpolation filter length for an interpolation filter associated with a CU based on a size of the CU; determining an interpolated reference sample based on a determined interpolation filter length for an interpolation filter and a reference sample for a CU; predicting a CU based on an interpolated reference sample.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, determining a size of a CU and a reference sample for the CU; determining whether to apply an interpolation filter on a reference sample for the CU based on a size of the CU; predicting a CU based on a determination of whether to apply an interpolation filter on a reference sample of a CU; determining an interpolation filter length for an interpolation filter associated with a CU based on a size of the CU; determining an interpolated reference sample based on a determined interpolation filter length for an interpolation filter and a reference sample for a CU; and/or predicting a CU based on an interpolated reference sample.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, for example, isIntraTop, isIntraLeft, cu_sbt_flag, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various examples refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain examples the encoder signals may include, for example, parameters for determining a CU size and/or an interpolation filter for a CU, an indication for enabling CIIP, an indication for enabling TPM, an indication for enabling MMVD etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various examples. It is to be appreciated that signaling can be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described example. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Each feature disclosed anywhere herein is described, and may be implemented, separately/individually and in any combination with any other feature disclosed herein and/or with any feature(s) disclosed elsewhere that may be impliedly or expressly referenced herein or may otherwise fall within the scope of the subject matter disclosed herein.

Video coding may be performed using various structures, formats, signaling mechanisms, modes, and/or partitions (for example, flexible multi-type tree block partitioning such quad-tree, binary tree, and/or ternary tree partitioning). Intra prediction may be performed. For example, one or more (for example, 65) angular intra prediction directions, including wide angle prediction, a chroma component linear model (CCLM), and/or matrix-based intra prediction (MP) may be used to code or decode video contents. Inter prediction may be performed. For example, an affine motion model, sub-block temporal motion vector prediction (SbTMVP), adaptive motion vector precision, decoder-side motion vector refinement (DMVR), triangular partitions, combined intra and inter prediction (CIIP), a merge mode with motion vector difference (MMVD), bi-directional optical flows (BDOF), a pixel refinement optical flow (PROF), and/or a bi-predictive weighted averaging (BPWA) may be used to code or decode video contents. Transform, quantization and/or coefficients coding may be performed. For example, multiple primary transform selection with discrete cosine transform 2 (DCT2), discrete sine transform 7 (DST7) and DCT8, secondary transform coding of low frequency non-separable transform (LFNST), dependent quantization with max QP increased from 51 to 63, and/or modified transform coefficient coding may be used to code or decode video contents. An in-loop filter (for example, a generalized adaptive loop filter (GALF)) may be used to code or decode video contents. Screen content coding (for example, intra block copy (IBC) and/or palette mode (PLT) for 4:4:4 content) may be performed. 360-degree video coding (for example, with or without horizontal wrap-around motion compensation) may be performed.

Bi-directional motion compensated prediction (MCP) may be increase prediction efficiency, for example, with respect to removing temporal redundancy by exploiting the temporal correlations between pictures. A bi-prediction signal may be formed by combining two uni-prediction signals using weight values (for example, weight values equal to 0.5). In some situations (for example, when illuminance changes rapidly from one reference picture to another), prediction techniques may aim at compensating the illuminance variation over time, for example, by applying global and/or local weights and/or offset values to one or more sample values (for example, to every sample value) in a reference picture.

An (for example, each) inter-predicted CU may include one or more motion parameters. The one or more motion parameters may include one or more of motion vectors, reference picture indices and/or reference picture list usage index, and/or additional information for inter-predicted sample generation. The one or more motion parameters may be signaled in an explicit or implicit manner. When a CU is coded with a skip mode, the CU may be associated with a PU and/or may not be associated with significant residual coefficients, a coded motion vector delta, or a reference picture index. In examples (for example, when a merge mode is specified), one or more motion parameters for a CU (for example, a current CU) may be obtained from one or more candidate (for example, neighboring CUs), including spatial candidates, temporal candidates and/or other types of candidates that may be suitable for the CU (for example, the current CU). In one or more examples, “neighboring” may be used interchangeably with “adjacent,” which includes different types of adjacency, such as an adjacent block, an adjacent sub-block, an adjacent pixel, and/or a pixel adjacent to a boundary. Spatial neighbors may be adjacent in the same frame while temporal neighbors may be at the same location in adjacent frames. A motion vector (MV) may be selected for a CU (for example, a current CU) from multiple MV candidates for the CU. The MV selected for the CU (for example, the current CU) may be associated with a reference picture for the CU (for example, including one or more reference samples in the reference picture). A MV associated with the reference sample may be determined based on the MV for the CU. A reference sample may be determined based on the MV associated with the reference sample. A merge mode may be applied to one or more inter-predicted CUs (for example, to any CU including those coded with the skip mode). Explicit transmission of motion parameters may be performed (for example, as an alternative to a merge mode). An explicit transmission of motion parameters may include a motion vector, a corresponding reference picture index for a (for example, each) reference picture list, a reference picture list usage flag, and/or other information to be used (for example, needed) for coding and/or decoding video contents. In examples, the transmission may be performed explicitly and/or for each CU.

A merge candidate list may be constructed, for example, by including one or more of the following types of candidates (for example, in order): a spatial motion vector predictor (MVP) associated with one or more spatial neighbour CUs, a temporal MVP associated with one or more collocated CUs, a history-based MVP from a FIFO table, a pairwise average MVP, or a zero MV.

A size of a merge list may be signalled, for example, in a slice header. In examples, a maximum allowed size of a merge list may be specified (for example, equal to 6). For a (for example, each) CU coded in a merge mode, an index specifying a best merge candidate may be encoded, for example, using truncated unary binarization (TU). There may be multiple bins of merge indices among which one or more bins (for example, the first bin) may be coded with context and one or more bins (for example, other than the first bin) may be coded using bypass coding.

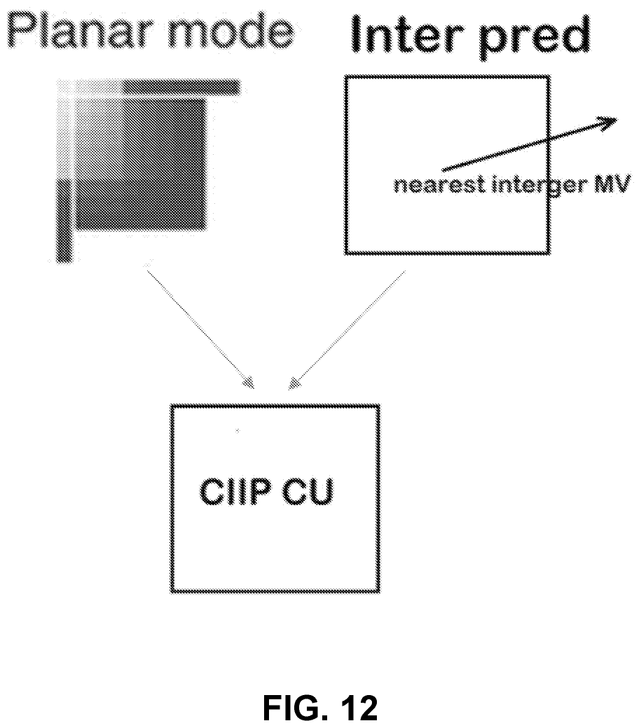

A combined inter and intra prediction (CIIP) mode may be used to code and/or decode a CU. Whether the CIIP mode is applied to a CU may be signaled, for example, in a video bitstream. For instance, when a CU is coded using a merge mode, if the number of luma samples (for example, determined by CU width times CU height) in the CU is equal to or above a threshold (for example, 64 luma samples) and if both the CU width and CU height are less than 128 luma samples, a flag may be signaled to indicate if the CIIP mode is applied to the CU (for example, the current CU). The CIIP prediction mode may combine an inter prediction signal with an intra prediction signal. FIG. 12 illustrates an example CIIP mode that uses a planar intra prediction mode and an inter prediction mode (for example, a nearest integer MV). An inter prediction signal in the CIIP mode Pᵢₙₜₑᵣ may be derived via a similar (for example, the same) inter prediction process as applied in a merge mode. An intra prediction signal in the CIIP mode Pᵢₙₜᵣₐ may be derived following a similar (for example, the same) intra prediction process as applied in the planar mode (for example, the planar mode shown in FIG. 12). The intra and inter prediction signals may be combined, for example, using weighted averaging. The weight values applied during the combination may be calculated based on the coding modes of one or more neighboring blocks of a CU (for example, a current CU) such as the top and left neighboring blocks of the CU (for example, the current CU).

FIG. 5 shows an example of deriving CIIP weights using top and left neighboring blocks. If a top neighboring block is available and intra-coded, a flag or variable (for example, named “isIntraTop”) may be set to 1. Otherwise (for example, if no top neighboring block is available or intra-coded), the flag or variable (for example, “isIntraTop”) may be set to 0. If a left neighbor is available and intra-coded, a flag or variable (for example, named “isIntraLeft”) may be set to 1. Otherwise (for example, if no left neighboring block is available or intra-coded), the flag or variable (for example, “isIntraLeft”) may be set to 0. In examples, if the sum of the two variables or flags (isIntraTop+isIntraLeft) is equal to 2 (for example, if both of the top and the left neighbors are available and intra-coded), a CIIP weight may be set to 3. If the sum of the two variables or flags (isIntraTop+isIntraLeft) is equal to 1 (for example, if only one of the top or left neighbor is available and intra-coded), the CIIP weight may be set to 2. If the sum of the two variables or flags (isIntraTop +isIntraLeft) is equal to 0 (for example, if neither the top nor the left neighbor is available and intra-coded), the CIIP weight may be set to 1.

A CIIP prediction may be performed as shown in Equation 1.

P_{CIIP}=((4−wt)*Pᵢₙₜₑᵣ+wt*Pᵢₙₜᵣₐ+2)>>2 (1)

wherein wt represents the CIIP weight described herein, Pᵢₙₜₑᵣ represents an inter prediction signal and Pᵢₙₜᵣₐ represents an intra prediction signal.

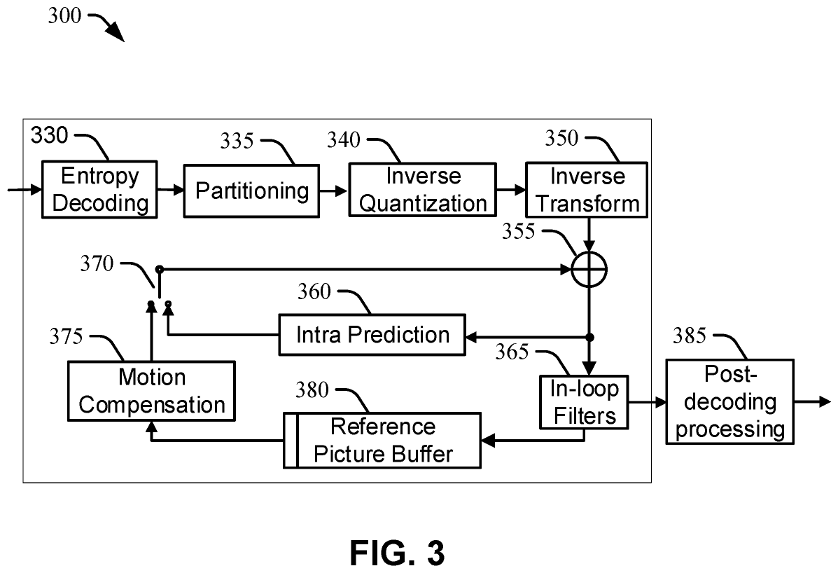

A triangle partition mode (TPM) may be supported for at least inter prediction. FIG. 6 shows an example triangle partition based inter prediction. TPM may be applied based on the size of a CU. For instance, TPM may be applied (for example, only applied) to CUs that are 8×8 or larger. TPM may be signalled using a flag or variable (for example, a CU-level flag or variable) as one type of merge modes (for example, other types of merge modes may include a regular merge mode, the MMVD mode, the CIIP mode, and the subblock merge mode, etc.).

When TPM is used, a CU may be split evenly, for example, into two triangle-shaped partitions (for example, using diagonal split or anti-diagonal split as shown in FIG. 6). A (for example, each) triangle partition in the CU may be inter-predicted using its own motion. Uni-prediction (for example, only uni-prediction) may be allowed for a partition, for example, each partition. A (for example, each) partition may include a motion vector and a reference index. A uni-prediction motion constraint may be applied (for example, similar to conventional bi-prediction), for example, to ensure that two (for example, only two) motion compensated predictions are performed for a CU. The uni-prediction motion for a (for example, each) partition may be derived as described herein.

If TPM is used for a CU (for example, a current CU), a flag or variable indicating a direction of the triangle partition (for example, diagonal or anti-diagonal) may be signalled. If TPM is used for a CU (for example, a current CU), two merge indices (for example, one for each partition) may be signalled. A maximum TPM candidate size may be signalled (for example, explicitly and/or at a slice level). The maximum TPM candidate size may specify syntax binarization for TPM merge indices. After predicting the triangle partitions (for example, each of the triangle partitions), one or more sample values along the diagonal and/or anti-diagonal edge may be adjusted, for example, using a blending process with adaptive weights. A prediction signal for the CU (for example, for the entire CU) may be used for transformation and quantization of the CU, for example, as in other prediction modes. A motion field of a CU predicted using TPM may be stored in 4×4 units as described herein.

In examples, TPM may not be used in combination with sub-block transform (SBT). For instance, when the TPM flag or variable has a value of 1 (for example, indicating TPM is applied), a SBT flag or variable (for example, cu_sbt_flag) may be determined to be 0 (for example, without explicit signaling of the SBT flag or variable).

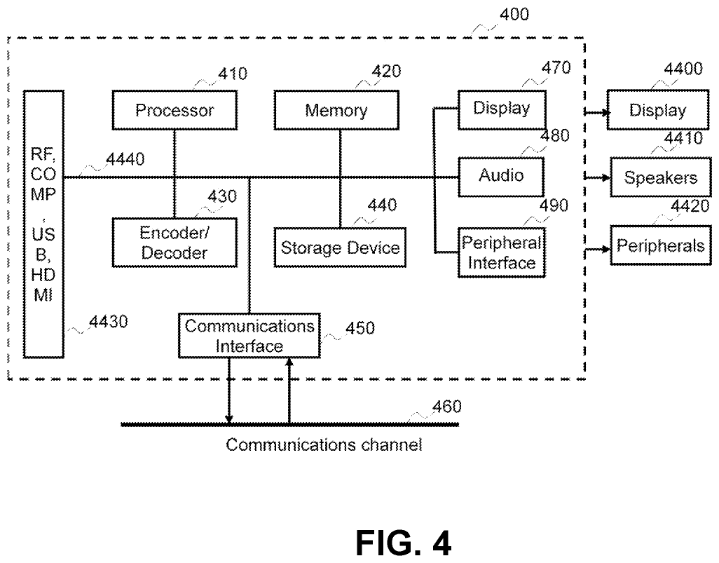

FIG. 7 shows an example of uni-prediction motion vector selection for TPM. A uni-prediction candidate list may be derived based on (for example, directly from) a merge candidate list constructed as described herein. For example, using n to denote the index of a uni-prediction motion in a triangle uni-prediction candidate list, a LX motion vector of the n-th extended merge candidate, with X equal to the parity of n, may be used as the n-th uni-prediction motion vector for TPM. These motion vectors are marked with “x” in FIG. 7. In examples (for example, when a corresponding LX motion vector of the n-the extended merge candidate does not exist), a L(1-X) motion vector of the same candidate may be used (for example, instead of the LX motion vector) as the uni-prediction motion vector for TPM.

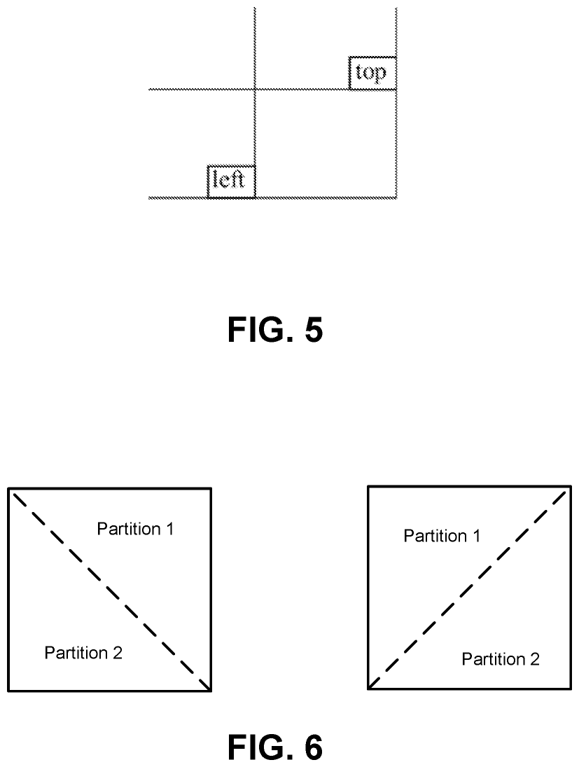

Blending may be applied along a triangle partition edge. FIG. 8 shows example weights that may be used in blending. Blending may be applied to the two prediction signals (for example, after triangle partitions P1 and P2 are predicted using their own motions), for example, to derive samples around the diagonal and/or anti-diagonal edge. As examples, the following weights may be used for blending: {⅞, 6/8, ⅝, 4/8, ⅜, 2/8, ⅛} for luma and { 6/8, 4/8, 2/8} for chroma, as shown in FIG. 8.

The motion vectors of a CU coded in a triangle partition mode (TPM) may be stored, for example, in 4×4 units. These motion vectors may include uni-prediction motion vectors and/or bi-prediction motion vectors, and the uni-prediction or bi-prediction motion vectors may be stored based on the respective positions of the relevant 4×4 units. For example, using Mv1 and Mv2 to represent uni-prediction motion vectors for partition 1 (P1) and partition 2 (P2), respectively, if a 4×4 unit is located in a non-weighted area (for example, areas of FIG. 8 that are not marked with weights), Mv1 or Mv2 may be stored for that 4×4 unit. Areas of FIG. 8 that are not marked with weights may comprise P1 and/or P2. If a 4×4 unit is located in a weighted area (for example, areas of FIG. 8 that are marked with weights), a bi-prediction motion vector may be stored for that 4×4 unit. The bi-prediction motion vector may be obtained, for example, using a blending process with adaptive weights as described herein. The bi-prediction motion vector may be obtained (for example, derived) from Mv1 and/or Mv2 based on one or more of the following. If Mv1 and Mv2 are from different reference picture lists (for example, one from reference picture list L0 and the other from reference picture list L1), Mv1 and Mv2 may be combined to form the bi-prediction motion vector. If Mv1 and Mv2 are both from a first reference picture list (for example, L0) but a reference picture of either Mv2 or Mv1 appears in a second reference picture list (for example, L1), then the motion vector with the reference picture in the second reference picture list may be converted to a motion vector associated with the second reference picture list using the reference picture in the second reference picture list, and the two motion vectors (for example, after the conversion) may be combined to form a bi-prediction motion vector. If Mv1 and Mv2 are both from a first reference picture list (for example, L0) and no reference picture of either Mv2 or Mv1 appears in a second reference picture list (for example, L1), then a uni-prediction motion (for example, only Mv1) may be stored.

A merge mode with motion vector differences (MMVD) may be used, for example, for a CU. In a merge mode, implicitly derived motion information may be used (for example, directly used) for generating prediction sample(s) of a CU (for example, a current CU). A MMVD flag may be signalled, for example, after sending a skip flag and a merge flag. The MMVD flag may indicate whether MMVD mode is used for a CU.

In a MMVD, a merge candidate may be selected. The merge candidate may be modified (for example, refined) by signalled MVDs information. The MVDs information may include one or more of: a merge candidate indication (for example, a merge candidate flag), an index to indicate (for example, specify) motion magnitude, and/or an index for an indication of a motion direction. In a MMVD, the merge candidate (for example, for the first two candidates in a merge list) may be selected to be used as a MV basis. The merge candidate indication may indicate which candidate in the merge list is used as the merge candidate.

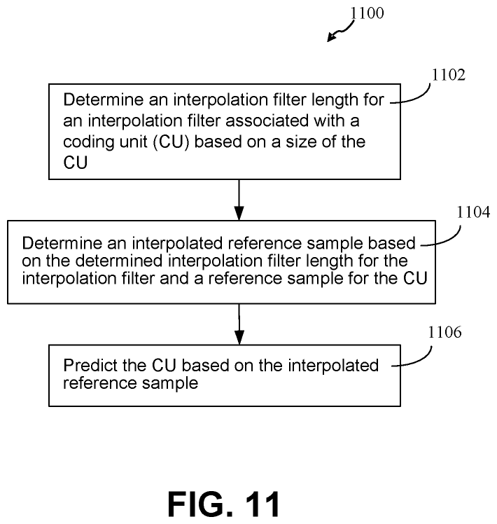

The resolution/precision of the motion vectors (MVs) may be 1/16 luma sample. For motion compensated prediction (MCP), reference samples (for example, sample values or MV associated the reference samples) at fractional positions may be determined via interpolation (for example, as shown in 1104 of FIG. 11). Interpolation may be based on, for example, one or more reference samples at an integer position(s). A MV associated a reference sample (for example, at an integer position) may be determined based on a MV associated with the CU. A video processing apparatus may support multiple (for example, four) types of interpolation filters including, for example, 8-tap filters, 6-tap filters, 4-tap filters, and/or 2-tap filters. The number of taps of a filter may correspond to or indicate the length of the filter (for example, more taps may correspond to a greater length). In an example, an interpolation filter length may be selected for an interpolation filter associated with a CU, and an interpolated reference sample may be determined based on the determined interpolation filter length for the interpolation filter, for example, by interpolating one or more reference samples for the CU. The CU may be predicted based on the interpolated reference sample, for example, by obtaining a MV with a fractional pixel resolution or precision. A MV with fractional pixel resolution or precision may provide higher prediction accuracy than a MV with integer pixel resolution or precision. In some examples, the fractional parts of a MV may lead to more computation complexities (for example, because of the multiplications involved in interpolation) and/or higher demand for memory access bandwidth (for example, in order to access multiple reference samples during interpolation). The costs (for example, due to computation and memory access) associated with the fractional parts of a MV may increase with longer interpolation filter lengths. In certain conditions, using a shorter interpolation filter length (for example, 4-tap or 2-tap instead of 8-tap or 6-tap) and/or no interpolation filtering (for example, nearest integer (for example, using a 1-tap interpolation filter length)) may reduce the processing costs while still maintain prediction accuracy. When the interpolation filter length is one, an interpolated reference sample may be the same as the reference sample, for example, if the one-tap interpolation filter is applied to the reference sample.

For the CIIP mode described herein, intra and inter prediction signals may be combined based on a weighted average. A shorter interpolation filter or nearest integer technique (for example, as shown in FIG. 12) may be adaptively used, for example, by a video processing apparatus, for inter-predicted signals in the CIIP mode. The accuracy loss for inter-predicted signals, if any, may be compensated for by intra-predicted signals, for example, depending on associated weighting factors.

For the TPM mode described herein, blending applied to the samples around diagonal and/or anti-diagonal edges may be performed based on a weighted average. A video processing apparatus may be configured to adaptively use a shorter interpolation filter or a nearest integer technique in the TPM mode for at least the samples located in a blending area. The accuracy loss for inter-predicted signals in one TPM partition, if any, may be compensated for by inter-predicted signals at another TPM partition, for example, based on a weighted average.

For reference samples that are determined to have smooth intensity values (for example, an object surface associated with the reference samples is smooth or the reference samples are reconstructed via smoothing operations such as Gaussian filtering), a video processing apparatus may be configured to use a shorter interpolation filter or apply a nearest integer technique for inter-predictions that are associated with the reference samples.

A video processing apparatus may be configured to apply interpolation filtering adaptively (for example, use an adaptive interpolation filter) for motion compensated prediction (MCP). Adaptive interpolation filtering may reduce interpolation induced computation complexities and/or memory access bandwidth usage without losing significant coding performance. The video processing apparatus may apply interpolation filtering adaptively (for example, use an adaptive interpolation filter) based on one or more factors including, for example, a coding mode, the video content, a CU size, etc. For example, the video processing apparatus may be configured to use a shorter interpolation filter or perform no interpolation filtering (for example, apply nearest integer technique or 1 tap interpolation filter) depending on the coding mode, video content and/or CU size to achieve a trade-off among coding efficiency, computation complexity, and memory access bandwidth. In an example, the video processing apparatus may determine whether to apply an interpolation filter on the reference sample for the CU based on the size of the CU. If the interpolation filter length for the interpolation filter is one, the interpolation filter may not be applied on the reference sample. The video processing apparatus may adaptively determine and/or adjust the precision of motion vectors, for example, to reduce signaling overhead (for example, at an encoder side) and/or to achieve higher coding efficiency. If the video processing apparatus determines that the interpolation filter is to be applied, the video processing apparatus may apply the interpolation filter on the reference sample for the CU, for example, to generate an interpolated reference sample, and predict the CU using the interpolated reference sample. If the video processing apparatus determines that the interpolation filter is not to be applied, the video processing apparatus may not apply the interpolation filter on the reference sample for the CU and predict the CU using the reference sample (for example, without interpolation).

Temporal scaling may be skipped (for example, may be removed) in a MMVD. In an example, temporal scaling may be removed in a MMVD, for example, if a CU is coded using true bi-prediction mode. Removing temporal scaling in a MMVD may reduce coding complexity and/or improve coding efficiency.

A video processing apparatus as described herein may be configured to adaptively select an interpolation filter based on a coding mode. In the CIIP mode, for example, the video processing apparatus may determine a weighted combination of intra prediction signals and inter prediction signals at a (for example, each) sample position, for example, as defined in Equation 1. The contribution of an inter prediction signal to the final prediction value may vary, for example, depending on a weight value wt (for example, as defined in Equation 1) used during the combination of the intra prediction signals and the inter prediction signals. The video processing apparatus may select a shorter interpolation filter when inter prediction signals are applied (for example, based on Equation 1) with a lower weight value such as (4−wt). The video processing apparatus may apply nearest integer technique. A nearest integer technique may be considered as a 1-tap interpolation filter or shortest interpolation filter. A 1-tap interpolation filter may be the shortest interpolation filter and/or may represent no interpolation filtering. In some examples, the interpolation filter length for a CU may be determined to be 1-tap and may be equivalent to skipping an interpolation filter(ing) for the reference sample(s) for the CU.

In examples, a video processing apparatus may map interpolation filter lengths to respective weight values (for example, wt), for example, based on a mapping table. Table 1 shows an example mapping table between a weight value wt and an interpolation filter length. As shown in Table 1, example adaptive MV precisions (for example, which may correspond to respective filter lengths) may be determined for different weight values (for example, in the CIIP mode).

TABLE 1
Example adaptive MV precisions for different
weight values in a CIIP mode

| Weight value wt | Length of the interpolation filter |
|---|---|
| 1 | 8-tap |
| 2 | 6-tap, or 4-tap, or 2-tap |
| 3 | nearest integer (for example, 1-tap) |

In examples, a video processing apparatus may be configured to use a nearest integer approach to determine the inter-prediction components of the CIIP mode, for example, independent of the weight value (for example, a nearest integer approach may be for various weight values including 1, 2, and 3).

A video processing apparatus may be configured to apply adaptive interpolation filtering in the TPM mode. As described herein, the video processing apparatus may be configured to perform weighted average-based blending to sub-block samples that are located at (for example, on or adjacent) diagonal and/or anti-diagonal edges during the TPM mode. The video processing apparatus may be further configured to determine non-edge sample values (for example, for samples not located on or adjacent to diagonal and/or anti-diagonal edges) using a first interpolation filter (for example, an 8-tap interpolation filter) and determine edge sample values using a second interpolation filter (for example, a shorter filter such as a 6-tap, 4-tap, 2-tap filter, or 1-tap filter without an interpolation or any interpolation). In examples, the video processing apparatus may be configured to determine the edge sample values using nearest integer technique (for example, without an interpolation filter). The video processing apparatus may compensate any loss of prediction accuracy from using a shorter interpolation filter with weighted blending (for example, which may be performed after the interpolation filtering).

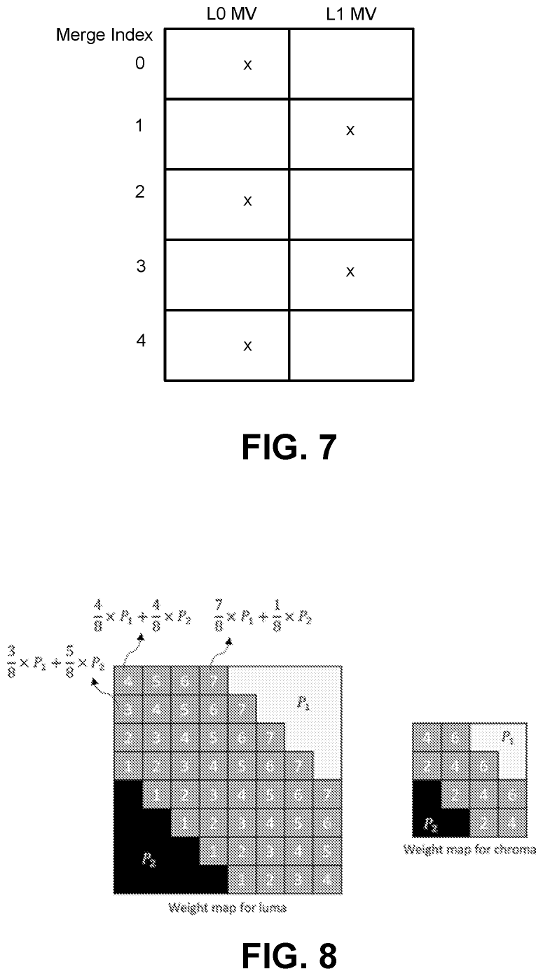

FIG. 9 shows an example of using different interpolation filters for sub-blocks inside or outside of a TPM edge area. As shown, a video processing apparatus may use a short interpolation filter (for example, 6, 4, 2, or 1 tap interpolation filter length) for samples of sub-blocks that are located at (for example, on or adjacent to) a diagonal or anti-diagonal edge. The video processing apparatus may use the short interpolation filter for samples (for example, all samples) within a sub-block (for example, an 8×8 sub-block) independent of the weights associated with the samples. For instance, as shown in FIG. 9, the video processing apparatus may use the short interpolation filter for edge samples associated with a first weight pair (for example, ⅞, ⅛ as shown in FIG. 8) and for edge samples associated with a second weight pair (for example, 4/8, 4/8 as shown in FIG. 8). A (for example, each) square in FIG. 9 may represent an 8×8 sub-block while A (for example, each) square in FIG. 8 may represent a sample.

In examples, a video processing apparatus may be configured to use a second (for example, shorter than a first) interpolation filter for samples located in a weighted area (for example, samples associated with a weight, as shown in FIG. 8) and use the first (for example, regular or original) interpolation filter (for example, an 8-tap filter) for samples located in a non-weighted area (for example, samples not associated with a weight, as shown in FIG. 8).

In examples, a video processing apparatus may be configured to use different interpolation filters (for example, filters with a shorter length) for sub-block samples that are located at (for example, on or adjacent to) a diagonal edge and for samples that are located at (for example, on or adjacent to) an anti-diagonal edge. For example, the video processing apparatus may be configured to consider the weight associated with a sample (for example, as shown in FIG. 8) when determining which interpolation filter length is suitable for the sample.

FIG. 10 shows an example of adaptive interpolation filters for samples associated with different weights (for example, in a TPM mode). For instance, as shown in FIG. 10, a video processing apparatus may be configured to use a 6-tap interpolation filter for edge samples associated with a first weight pair (for example, ⅞, ⅛) (for example, see FIG. 8) and use a 1-tap interpolation filter (for example, nearest integer technique) for edge samples associated with a second weight pair (for example, 4/8, 4/8). A number of taps for the interpolation filter may indicate a length of the interpolation filter.

A video processing apparatus may be configured to apply adaptively interpolation filtering in other weighted bi-prediction modes such as bi-prediction with CU-level weights. For example, the video processing apparatus may determine the length of an interpolation filter adaptively (for example, dynamically) based on one or more weights values to be applied in the bi-prediction. The video processing apparatus may also determine the length of an interpolation filter based on pre-defined values (for example, independent of the applicable weights values). Potential loss associated with using a shorter length interpolation filter, if any, in these bi-prediction modes may be compensated by the weighting applied during the bi-prediction.

For example, adaptive interpolation filtering may be used in a bi-prediction mode. Inter-predicted signals may use a shorter length of interpolation filter (e.g., such as neatest integer method) which may reduce MC computing complexity. A shorter length interpolation filter may be shorter than is used in one or more other modes such as CIIP mode, TPM mode, and/or weighted bi-prediction mode. The use of a shorter length interpolation filter may not lead to significant coding performance loss. The combined signals (e.g., weighted or equally combined) in bi-prediction may compensate the coding loss from either uni-predicted signal.

Inter-prediction of CIIP may use bi-prediction (e.g., bi-prediction mode). In examples, if the inter-prediction part of the CIIP uses bi-prediction mode, a shorter length of interpolation filter (e.g., such as nearest integer method) may be used to generate inter prediction signals. A shorter length of interpolation filter may be used regardless of the weights that are used to combine intra prediction signals and inter prediction signals. In examples, if the inter-prediction part of the CIIP uses a bi-prediction mode, the weights that are used to combine intra prediction signals and inter prediction signals may be considered for determining the length of the interpolation filter. For example, when weight value wt is 2 or 3 and the inter prediction signals are generated by bi-prediction, a shorter length of interpolation filter (e.g., such as nearest integer method) may be used to generate one or more inter prediction signals. When a weight value wt is 2 or 3, intra prediction signals may be equally or more important than inter prediction signals during weighted combination operation in CIIP.

A video processing apparatus may be configured to apply adaptive interpolation filtering based on the video content (for example, to be processed or being processed). For example, the video processing apparatus may adaptively select an interpolation filter based on whether the video content includes sharp edges and/or whether the video content includes smooth sample values (for example, naturally smooth values such as those associated with a smooth object surface, or reconstructed smooth sample values such as interpolated reference samples with a high MV precision).

A video processing apparatus may send (for example, if the video processing apparatus is an encoder) or receive (for example, if the video processing apparatus is a decoder) signaling that indicates whether reference samples in a reference CU or a reference block have smooth sample values or sample values associated with sharp transitions such as edges. The indication may be sent (for example, from an encoder side) during motion estimation and/or may be set or flagged (for example, at a decoder side) during motion compensation, for example, when reconstructing reference blocks in the same picture or a different picture.

A video processing apparatus (for example, an encoder) may analyze the characteristics of video contents, for example, when different encoding modes are evaluated. The analysis may be conducted using a smoothness detection technique described herein. If smooth contents (for example, smooth sample values) are identified in a CU based on the analysis, the video processing apparatus may send an indication that the CU includes smooth contents. Responsive to receiving such an indication, a video processing apparatus (for example, a decoder) may apply a shorter interpolation filter to one or more samples of the CU. The indication (for example, of smoothness) may be provided for an intra-predicted CU (for example, only for intra CUs). The smoothness information of a reference region may be determined (for example, inferred) from the smoothness information of a reference picture that is associated with the motion vectors (for example, MVs involved in the motion estimation or motion compensation).

A video encoding apparatus may be configured to determine (for example, detect) the smoothness of video contents based on gradients in the horizontal, vertical, and/or one or two diagonal directions. The video encoding apparatus may obtain (for example, calculate) these gradients using an array such as a 1-D Laplacian. The video encoding apparatus may determine a gradient threshold value, for example, based on a calculated gradient map of a CU, by statistically measuring whether a CU is smooth or not, and/or by calculating a standard deviation of the luma samples within a CU (for example, a calculated standard deviation of luma samples within a CU may statistically indicate whether the CU is smooth or not).

When a reference CU or block associated with a CU (for example a current CU) has been decoded or reconstructed, a video decoding apparatus (for example, a decoder) may determine the smoothness of the reference CU or block and/or adaptively select a long or short interpolation filter based on the determination. The smoothness analysis may be performed for intra CUs (for example, only for intra CUs). The smoothness information (for example, which CU(s) and/or block(s) are smooth) may be stored for processing subsequent video (for example, pictures, frames, slices etc). For inter CUs, the video decoding apparatus may determine (for example, infer) the smoothness information of a reference region from stored smoothness information for a reference picture and its associated motion vectors. The video decoding apparatus may reconstruct the reference CU(s) and/or block(s) in the reference region and/or perform the smoothness detection based on the reconstructed CU(s) or block(s), for example, using the techniques described herein.

A video processing apparatus may be configured to apply nearest integer during motion compensation, for example, when the video content includes or is determined to include sharp edges (for example, such as screen content). In some example, the video processing apparatus may be configured to use a shorter interpolation filter or nearest integer during motion compensation, for example, when the video content includes smooth sample values (for example, as determined by the video processing apparatus).

A video processing apparatus may be configured to select an interpolation filter adaptively based on the size of a CU (for example, as shown in 1102 of FIG. 11). A CU size may represent a spatial resolution of a sub-picture (for example, a CU may be considered a sub-picture). The video processing apparatus may obtain a size of a CU. When a certain sized sub-picture (for example, a CU) is considered by the video processing apparatus (for example, an encoder) to find a match from a reference picture, the MV precision that is to be used (for example, should be used) to find the match may be determined based on the size of the CU. For example, the video processing apparatus may use a higher MV precision to find a match for a CU of a larger size (for example, due to the CU's higher spatial resolution) and use a lower MV precision to find a match for a CU of a smaller size.

4×4 CUs may be allowed (for example, only allowed) for an affine mode, while 8×4 or 4×8 CUs may be allowed for an inter coding mode (for example, the largest CU size allowed for the inter mode may be 128×128). A video processing apparatus may be configured (for example, allowed) to use respective sets of one or more interpolation filters (for example, of different lengths including at least a first and second lengths) for different ranges of CU sizes (for example, including at least a first and second CU sizes). The video processing apparatus may be configured to select an interpolation filter or determine the length of an interpolation filter associated with a CU based on the size of the CU (for example, as shown in 1102 of FIG. 11). For instance, the video processing apparatus may be configured to use a first (for example, a shorter interpolation filter) for samples of a first CU (for example, a larger CU) and use a second (for example, a longer interpolation filter) for samples of a second (for example, a smaller) CU.

An affine mode CU may comprise one or more 4×4 sub-blocks. A video processing apparatus may perform motion compensation for such an affine mode CU using MVs associated with 4×4 sub-blocks (for example, 4×4 sub-blocks of the CU). These 4×4 sub-block MVs may be derived from the same set of (for example, two or three) CU affine MVs. The video processing apparatus may select an interpolation filter or determine the length of an interpolation filter associated with a CU based on the size of the CU (for example, independent of the 4×4 sub-block size).

When a CU size is considered to determine a length of an interpolation filter, the determined length of the interpolation filter may be considered to determine a CU size constraint. For example, a CIIP mode may not be applied to small size CUs (for example, 8×8 CUs). Not applying CIIP mode to small size CUs may reduce coding complexity. If a shorter length interpolation filter (for example, 2-tap or nearest integer method (1-tap)) is decided for a CU based on one or more other proposed factors (for example, content dependent, picture dependent, etc.), which reduces CIIP complexity, a CU size restriction (for example, constraint) may be removed. A CU size constraint (for example, larger CU or smaller CU does not apply CIIP) may be used for enabling or used to determine whether to enable the CIIP mode in a CU. A CU size constraint may be removed when a shorter length interpolation filter (for example, 2-tap, 1-tap or nearest integer method) is determined for a CU, for example, in some inter-prediction mode(s) such as a bi-prediction mode.

In examples, when a short length interpolation filter or a nearest integer method is used, a CIIP mode may be applied to small CUs (for example, 4×8 or 8×4 CUs).

CIIP may be applied to non-small CUs (for example, 8×8 and bigger CUs). When a nearest integer method is used, an integer MV may be used in CIIP.

In examples, CIIP coded small CUs (for example, 4×8 or 8×4 CUs) may or may not use integer MV.

In examples, when a CIIP mode is applied to small CUs (for example, such as 4×8 or 8×4 CUs), signaling of CIIP may be skipped. For small CUs (for example, 4×8 or 8×4 CUs), many other encoding modes (for example, a TPM mode) may not be applicable. When other encoding modes are not applicable, there may be no need to differentiate, via signaling, which mode is applied. In this case, small CUs (for example, merge mode CUs which are not in regular merger mode) may be derived (for example, directly derived) using CIIP without parsing signaling bit, for example, because there is no associated signaling bit sent.

When CIIP is applied to small CUs (for example, 4×8 or 8×4 CUs), and if small CUs are coded with CIIP, signaling may be skipped. The CIIP coded small CUs may not use integer MVs, for example, since the complexity for small CUs is insignificant. The complexity for small CUs may be insignificant due to use of uni-prediction.

Filter selection may be adapted based on a picture type. For example, picture dependent adaptive interpolation filtering may be used in one or more modes. A shorter length interpolation filter may be used (for example, only used) for low delay pictures. When a shorter length interpolation filter is used for low delay pictures, a lower MC complexity and/or delay may be achieved. MC accuracy for low delay pictures may be more important than MC complexity, for example, so that low delay pictures use (for example, always use) a longer interpolation filter length.

Inter prediction signals generated for a CIIP mode may consider whether the prediction is bi-prediction and/or the picture type. In CIIP, if a bi-prediction mode is used for the inter prediction and the picture type is low delay pictures, a shorter interpolation filter length (for example, such as nearest integer method) may be used to generate one or more inter prediction signals. In CIIP, if a bi-prediction mode is used for the inter prediction, the weight value wt used is 2 or 3, and the picture type is low delay pictures, a shorter interpolation filter length (for example, such as nearest integer method) may be used to generate one or more inter prediction signals.

A video processing apparatus may be configured to perform adaptive interpolation filtering based on various combinations of the approaches described herein.

A video processing apparatus may be configured to determine the precision of a motion vector adaptively, for example, using a hybrid approach. The precision of a MV may not significantly change the complexity of an interpolation operation. The precision of a MV may determine the number of bits to be used for signaling a MV value such as a MV difference. The number of bits to be used for signaling the MV value may affect video coding performance. The video processing apparatus may determine a MV precision adaptively based on various combinations of the approaches described herein, for example, to improve coding efficiency. For example, if the CIIP mode is extended to explicit inter mode, a MV precision may depend on the weight(s) (for example, that is applied or to be applied). A video processing apparatus may set an initial MV precision at a quarter-luma-sample (for example, ¼-PEL). With such a quarter-luma-sample precision, it may take two bits to signal fractional motion information (for example, MVD). If a weight value (for example, the wt described herein) is set at 3, an inter-predicted sample value may be negligible (for example, as shown in Equation 1). In these examples (for example, when the inter-predicted value is negligible), a lower MV precision such as a half-luma-sample (for example, ½-PEL) precision may be signaled. With such a half-luma-sample precision, it may take one bit to signal the motion information. As a result, bit savings may be achieved for each applicable coding unit (for example, when the half-luma-sample precision is used instead of the quarter-luma-sample precision).

When MMVD is used, if the starting MVs of a CU are bi-prediction MVs with different distances (for example, POC difference) from both reference pictures to a picture (for example, the current picture), temporal scaling may be applied.

If a CU is coded using a true bi-prediction mode, temporal scaling may be skipped (for example, may be removed) in MMVD. In a true bi-prediction mode, one of the two reference pictures may be prior to a picture (for example, prior to a current picture in a display order) and the other of the two reference pictures may be after the picture (for example, after the current picture in the display order). When temporal scaling is not applied in MMVD, complexity may be reduced and/or higher coding efficiency may be achieved. In a true bi-prediction mode, whether temporal scaling is performed or not, one or more final prediction signals may not be changed significantly (for example, may not be changed).

A merge motion vector difference may be derived as follows. If the Sign(currPocDiffL0) is equal to Sign(currPocDiffL1), list-0 reference picture L0 and list-1 reference picture L1 may be from a same side of a picture (for example, either forward or backward). The picture may include a current picture. Otherwise if (Sign(currPocDiffL0) is not equal to Sign(currPocDiffL1)), those two reference pictures may be from two sides of a picture (for example, one reference picture is from a forward direction of a current picture. and the other reference pictures is from a backward direction of the current picture). Temporal scaling may not be applied (for example, skipped) when the two reference pictures are from two directions (e.g., when Sign(currPocDiffL0) is not equal to Sign(currPocDiffL1)).

The luma merge motion vector differences mMvdL0 and mMvdL1 may be obtained (for example, derived) as follows:

```
If both predFlagL0 and predFlagL1 are equal to 1, the following may apply:
  currPocDiffL0 = DiffPicOrderCnt( currPic, RefPicList[ 0 ][ refIdxL0 ] ) (2)
  currPocDiffL1 = DiffPicOrderCnt( currPic, RefPicList[ 1 ][ refIdxL1 ] ) (3)
If currPocDiffL0 is equal to currPocDiffL1, the following may apply:
  mMvdL0[ 0 ] = MmvdOffset[ xCb ][ yCb ][ 0 ] (4)
  mMvdL0[ 1 ] = MmvdOffset[ xCb ][ yCb ][ 1 ] (5)
  mMvdL1[ 0 ] = MmvdOffset[ xCb ][ yCb ][ 0 ] (6)
  mMvdL1[ 1 ] = MmvdOffset[ xCb ][ yCb ][ 1 ] (7)
Otherwise, if Abs( currPocDiffL0 ) is greater than or equal to Abs( currPocDiffL1 ), the following
may apply:
  mMvdL0[ 0 ] = MmvdOffset[ xCb ][ yCb ][ 0 ] (8)
  mMvdL0[ 1 ] = MmvdOffset[ xCb ][ yCb ][ 1 ] (9)
If RefPicList[ 0 ][ refIdxL0 ] is not a long-term reference picture and RefPicList[ 1 ][ refIdxL1 ] is not
a long-term reference picture, and Sign( currPocDiffL0 ) is equal to Sign( currPocDiffL1 ), the
following may apply:
  td = Clip3( −128, 127, currPocDiffL0 ) (10)
  1tb = Clip3( −128, 127, currPocDiffL1 ) (11)
  tx = ( 16384 + ( Abs( td ) >> 1 ) ) / td (12)
  distScaleFactor = Clip3( −4096, 4095, ( tb * tx + 32 ) >> 6 ) (13)
  mMvdL1[ 0 ] = Clip3( −2¹⁵, 2¹⁵ − 1, (distScaleFactor * mMvdL0[ 0 ] + (14)
    128 − ( distScaleFactor * mMvdL0[ 0 ] >= 0 ) ) >> 8 )
  mMvdL1[ 1 ] = Clip3( −2¹⁵, 2¹⁵ − 1, (distScaleFactor * mMvdL0[ 1 ] + (15)
    128 − ( distScaleFactor * mMvdL0[ 1 ] >= 0 ) ) >> 8 )
Otherwise, the following may apply:
  mMvdL1[ 0 ] = Sign( currPocDiffL0 ) = = Sign( currPocDiffL1 ) ?
      mMvdL0[ 0 ] : −mMvdL0[ 0 ] (16)
  mMvdL1[ 1 ] = Sign( currPocDiffL0 ) = = Sign( currPocDiffL1) ?
      mMvdL0[ 1 ] : −mMvdL0[ 1 ] (17)
Otherwise (Abs( currPocDiffL0 ) is less than Abs( currPocDiffL1 )), the following may apply:
  mMvdL1[ 0 ] = MmvdOffset[ xCb ][ yCb ][ 0 ] (18)
  mMvdL1[ 1 ] = MmvdOffset[ xCb ][ yCb ][ 1 ] (19)
If RefPicList[ 0 ][ refIdxL0 ] is not a long-term reference picture and RefPicList[ 1 ][ refIdxL1 ] is not
a long-term reference picture, and Sign( currPocDiffL0 ) is equal to Sign( currPocDiffL1 ), the
following may apply:
  td = Clip3( −128, 127, currPocDiffL1 ) (20)
  tb = Clip3( −128, 127, currPocDiffL0 ) (21)
  tx = ( 16384 + ( Abs( td ) >> 1 ) ) / td (22)
distScaleFactor = Clip3( −4096, 4095, ( tb * tx + 32 ) >> 6 ) (23)
  mMvdL0[ 0 ] = Clip3( −2¹⁵, 2¹⁵ − 1, (distScaleFactor * mMvdL1[ 0 ] + (24)
        128 − (distScaleFactor * mMvdL1[ 0 ] >= 0) ) >> 8 )
  mMvdL0[ 1 ] = Clip3( −2¹⁵, 2¹⁵ − 1, , (distScaleFactor * mMvdL1[ 1 ] + (8-405)
        128 − (distScaleFactor * mMvdL1[ 1 ] >= 0) ) >> 8 ) )
Otherwise, the following may apply:
  mMvdL0[ 0 ] = Sign( currPocDiffL0 ) = = Sign( currPocDiffL1 ) ?
      mMvdL1[ 0 ] : −mMvdL1[ 0 ] (25)
  mMvdL0[ 1 ] = Sign( currPocDiffL0 ) = = Sign( currPocDiffL1) ?
      mMvdL1[ 1 ] : −mMvdL1[ 1 ] (26)
```

FIG. 11 illustrates a method 1100 of performing adaptive interpolation based on a CU size. The method 1100 may be used, for example, to apply motion compensation to a coding unit. The method 1100 may be implemented by a video processing apparatus as described herein including a decoder and/or an encoder, and the examples disclosed herein may operate in accordance with the method shown in FIG. 11. The method 1100 may comprise 1102, 1104 and 1106. At 1102, a video processing apparatus may determine an interpolation filter length for an interpolation filter associated with a CU based on a size of the CU. At 1104, the video processing apparatus may generate an interpolated reference sample based on the determined interpolation filter length for the interpolation filter and a reference sample for the CU. At 1106, the video processing apparatus may predict the CU based on the interpolated reference sample. When the method of FIG. 11 is implemented by a decoder, 1102-1106 may be associated with decoding a CU based on the interpolated reference sample. When the method of FIG. 11 is implemented by an encoder, 1102-1106 may be associated with encoding a CU based on the interpolated reference sample.

Many embodiments are described herein. Features of embodiments may be provided alone or in any combination, across various claim categories and types. Further, embodiments may include one or more of the features, devices, or aspects described herein, alone or in any combination, across various claim categories and types, such as, for example, any of the following.

A decoder may determine an interpolation filter length for an interpolation filter associated with a CU. The decoder (such as example decoder 300 operating in accordance with the example method shown in FIG. 11) may determine an interpolation filter length for an interpolation filter associated with a CU based on a size of the CU, for example, as described herein. The decoder may determine an interpolated reference sample based on the determined interpolation filter length for the interpolation filter and based on a reference sample for the CU, for example, as described herein. The decoder may predict the CU based on the interpolated reference sample, for example, as described herein. In some examples as described herein, the decoder may determine a size of a CU and a reference sample for the CU; determine whether to apply an interpolation filter on the reference sample for the CU based on the size of the CU; and predict the CU based on the determination of whether to apply the interpolation filter on the reference sample for the CU. As described herein, the decoder may determine that an interpolation filter length for the interpolation filter is one based on the size of the CU, may not apply the interpolation filter on the reference sample based on the determination that the interpolation filter length for the interpolation filter is one, and may predict the CU using the reference sample for the CU. As described herein, the decoder may determine an interpolation filter length for the interpolation filter associated with the CU based on the size of the CU, when the interpolation filter length for the interpolation filter is not one, may determine an interpolated reference sample based on the determined interpolation filter length for the interpolation filter and the reference sample for the CU, and may predict the CU based on the interpolated reference sample. The decoder may select a MV for the CU from a plurality of MV candidates for the CU, for example, in a merge mode as described herein. The decoder may determine a MV associated with the reference sample based on the MV for the CU, for example, using a selected MV candidate as described herein. The decoder may determine the reference sample based on the MV associated with the reference sample, for example, as described herein. The decoder may perform an interpolation using the reference sample (for example, at an integer position in a reference CU) and the interpolation filter that has the determined interpolation filter length, to determine the interpolated reference sample (for example, at a fractional position associated with the reference CU), for example, as described herein. For a 4×4 sub-block in the CU, the decoder may determine a MV for the 4×4 sub-block in the CU based on at least a MV associated with the CU and predict the CU in an affine mode and based on the determined MV for the 4×4 sub-block in the CU, for example, as described herein. The decoder may determine a first interpolation filter length for a first interpolation filter associated with a first CU based on a first CU size of the first CU and determine a second interpolation filter length for a second interpolation filter associated with a second CU based on a second CU size of the second CU, for example, as described herein. When the first CU size is greater than the second CU size, the first interpolation filter length is less than the second interpolation filter length, for example, as described herein. The decoder may determine the interpolation filter length based on a number of taps for the interpolation filter that indicates the interpolation filter length, for example, as described herein. The decoder may determine that the interpolation reference sample is the same as the reference sample when the interpolation filter length is one, for example, as described herein. The decoder may determine the interpolation filter associated with the CU is an adaptive interpolation filter, for example, as described herein.

Decoding tools and techniques including one or more of entropy decoding, inverse quantization, inverse transformation, and differential decoding may be used to enable the method as described in FIG. 11 in the decoder. These decoding tools and techniques may be used to enable one or more of: determining an interpolation filter length for an interpolation filter associated with a CU; determining an interpolation filter length for an interpolation filter associated with a CU based on a size of the CU, for example, as described herein; determining an interpolated reference sample based on the determined interpolation filter length for the interpolation filter and a reference sample for the CU, for example, as described herein; predicting the CU based on the interpolated reference sample, for example, as described herein; determining a size of a CU and a reference sample for the CU, for example, as described herein; determining whether to apply an interpolation filter on the reference sample for the CU based on the size of the CU, for example, as described herein; predicting the CU based on the determination of whether to apply the interpolation filter on the reference sample for the CU, for example, as described herein; determining that an interpolation filter length for the interpolation filter is one based on the size of the CU, not applying the interpolation filter on the reference sample based on the determination that the interpolation filter length for the interpolation filter is one, and predicting the CU using the reference sample for the CU, for example, as described herein; determining an interpolation filter length for the interpolation filter associated with the CU based on the size of the CU, when the interpolation filter length for the interpolation filter is not one, determining an interpolated reference sample based on the determined interpolation filter length for the interpolation filter and the reference sample for the CU, and predicting the CU based on the interpolated reference sample, for example, as described herein; selecting a MV for the CU from a plurality of MV candidates for the CU, for example, in a merge mode as described herein; determining a MV associated with the reference sample based on the MV for the CU, for example, using a selected MV candidate as described herein; determining the reference sample based on the MV associated with the reference sample, for example, as described herein; performing an interpolation using the reference sample (for example, at an integer position in a reference CU) and the interpolation filter that has the determined interpolation filter length, to determine the interpolated reference sample (for example, at a fractional position associated with the reference CU), for example, as described herein; determining a MV for a 4×4 sub-block in the CU based on at least a MV associated with the CU and predicting the CU in an affine mode and based on the determined MV for the 4×4 sub-block in the CU, for example, as described herein; determining a first interpolation filter length for a first interpolation filter associated with a first CU based on a first CU size of the first CU and determining a second interpolation filter length for a second interpolation filter associated with a second CU based on a second CU size of the second CU, for example, as described herein; when the first CU size is greater than the second CU size, determining the first interpolation filter length is less than the second interpolation filter length, for example, as described herein; determining the interpolation filter length based on a number of taps for the interpolation filter that indicates the interpolation filter length, for example, as described herein; determining that the interpolation reference sample is the same as the reference sample when the interpolation filter length is one, for example, as described herein; determining the interpolation filter associated with the CU is an adaptive interpolation filter, for example, as described herein; and other decoder behaviors that are related to any of the above.

An encoder may determine an interpolation filter length for an interpolation filter associated with a CU. The encoder (such as example encoder 300 operating in accordance with the example method shown in FIG. 11) may determine an interpolation filter length for an interpolation filter associated with a CU based on a size of the CU, for example, as described herein. The encoder may determine an interpolated reference sample based on the determined interpolation filter length for the interpolation filter and a reference sample for the CU, for example, as described herein. The encoder may predict the CU based on the interpolated reference sample, for example, as described herein. In some examples as described herein, the encoder may determine a size of a CU and a reference sample for the CU; determine whether to apply an interpolation filter on the reference sample for the CU based on the size of the CU; and predict the CU based on the determination of whether to apply the interpolation filter on the reference sample for the CU. As described herein, the encoder may determine that an interpolation filter length for the interpolation filter is one based on the size of the CU, may not apply the interpolation filter on the reference sample based on the determination that the interpolation filter length for the interpolation filter is one, and may predict the CU using the reference sample for the CU. As described herein, the encoder may determine an interpolation filter length for the interpolation filter associated with the CU based on the size of the CU, when the interpolation filter length for the interpolation filter is not one, may determine an interpolated reference sample based on the determined interpolation filter length for the interpolation filter and the reference sample for the CU, and may predict the CU based on the interpolated reference sample. The encoder may perform an interpolation using the reference sample (for example, at an integer position in a reference CU) and the interpolation filter that has the determined interpolation filter length, to determine the interpolated reference sample (for example, at a fractional position associated with the reference CU), for example, as described herein. For a 4×4 sub-block in the CU, the encoder may determine a MV for the 4×4 sub-block in the CU based on at least a MV associated with the CU and predict the CU in an affine mode and based on the determined MV for the 4×4 sub-block in the CU, for example, as described herein. The encoder may determine a first interpolation filter length for a first interpolation filter associated with a first CU based on a first CU size of the first CU and determine a second interpolation filter length for a second interpolation filter associated with a second CU based on a second CU size of the second CU, for example, as described herein. When the first CU size is greater than the second CU size, the first interpolation filter length is less than the second interpolation filter length, for example, as described herein. The encoder may determine the interpolation filter length based on a number of taps for the interpolation filter that indicates the interpolation filter length, for example, as described herein. The encoder may determine that the interpolation reference sample is the same as the reference sample when the interpolation filter length is one, for example, as described herein. The encoder may determine the interpolation filter associated with the CU is an adaptive interpolation filter, for example, as described herein.

Encoding tools and techniques including one or more of quantization, entropy coding, inverse quantization, inverse transformation, and differential coding may be used to enable the method as described in FIG. 11 in the encoder. These encoding tools and techniques may be used to enable one or more of: determining an interpolation filter length for an interpolation filter associated with a CU; determining an interpolation filter length for an interpolation filter associated with a CU based on a size of the CU, for example, as described herein; determining an interpolated reference sample based on the determined interpolation filter length for the interpolation filter and a reference sample for the CU, for example, as described herein; predicting the CU based on the interpolated reference sample, for example, as described herein; determining a size of a CU and a reference sample for the CU, for example, as described herein; determining whether to apply an interpolation filter on the reference sample for the CU based on the size of the CU, for example, as described herein; predicting the CU based on the determination of whether to apply the interpolation filter on the reference sample for the CU, for example, as described herein; determining that an interpolation filter length for the interpolation filter is one based on the size of the CU, not applying the interpolation filter on the reference sample based on the determination that the interpolation filter length for the interpolation filter is one, and predicting the CU using the reference sample for the CU, for example, as described herein; determining an interpolation filter length for the interpolation filter associated with the CU based on the size of the CU, when the interpolation filter length for the interpolation filter is not one, determining an interpolated reference sample based on the determined interpolation filter length for the interpolation filter and the reference sample for the CU, and predicting the CU based on the interpolated reference sample, for example, as described herein; selecting a MV for the CU from a plurality of MV candidates for the CU, for example, in a merge mode as described herein; determining a MV associated with the reference sample based on the MV for the CU, for example, using a selected MV candidate as described herein; determining the reference sample based on the MV associated with the reference sample, for example, as described herein; performing an interpolation using the reference sample (for example, at an integer position in a reference CU) and the interpolation filter that has the determined interpolation filter length, to determine the interpolated reference sample (for example, at a fractional position associated with the reference CU), for example, as described herein; determining a MV for a 4×4 sub-block in the CU based on at least a MV associated with the CU and predicting the CU in an affine mode and based on the determined MV for the 4×4 sub-block in the CU, for example, as described herein; determining a first interpolation filter length for a first interpolation filter associated with a first CU based on a first CU size of the first CU and determining a second interpolation filter length for a second interpolation filter associated with a second CU based on a second CU size of the second CU, for example, as described herein; when the first CU size is greater than the second CU size, determining the first interpolation filter length is less than the second interpolation filter length, for example, as described herein; determining the interpolation filter length based on a number of taps for the interpolation filter that indicates the interpolation filter length, for example, as described herein; determining that the interpolation reference sample is the same as the reference sample when the interpolation filter length is one, for example, as described herein; determining the interpolation filter associated with the CU is an adaptive interpolation filter, for example, as described herein; and other encoder behaviors that are related to any of the above.

A syntax element(s) may be inserted in the signaling, for example, to enable the decoder to identify an indication associated with performing the method as described in FIG. 11, or the method to use. For example, the syntax element may include information used to determine a CU size or a MV for a CU, and/or an indication of a parameter that the decoder uses to perform one or more examples herein.

The method as described in FIG. 11 may be selected and/or applied, for example, based on the syntax element(s) to apply at the decoder. For example, the decoder may receive information about a CU size. The decoder may determine the CU size and a reference sample for the CU; determine whether to apply an interpolation filter on the reference sample for the CU based on the CU size; predict the CU based on the determination of whether to apply the interpolation filter on the reference sample for the CU; determine an interpolation filter length for an interpolation filter associated with a CU based on the CU size; determine an interpolated reference sample based on the determined interpolation filter length for the interpolation filter and a reference sample for the CU; and/or predict the CU based on the interpolated reference sample.

The encoder may adapt prediction residual based on one or more examples herein. A residual may be obtained, for example, by subtracting a predicted video block from the original image block. For example, the encoder may predict a video block based on the interpolated reference sample (or the reference sample) obtained as described herein. The encoder may obtain the original image block and subtract the predicted video block from the original image block to generate a prediction residual.

A bitstream or signal may include one or more of the described syntax elements, or variations thereof. For example, a bitstream or signal may include a syntax element(s) that indicates any of information used to determine a CU size or a MV for a CU, and/or an indication of a parameter that the decoder uses to perform one or more examples herein.

A bitstream or signal may include syntax conveying information generated according to one or more examples herein. For example, information or data may be generated in performing the example as shown in FIG. 11. The generated information or data may be conveyed in syntax included in the bitstream or signal.

Syntax elements that enable the decoder to adapt a residue(s) in a manner corresponding to that used by an encoder may be inserted in a signal. For example, the residual may be generated using one or more examples herein.

A method, process, apparatus, medium storing instructions, medium storing data, or signal for creating and/or transmitting and/or receiving and/or decoding a bitstream or signal that includes one or more of the described syntax elements, or variations thereof.

A method, process, apparatus, medium storing instructions, medium storing data, or signal for creating and/or transmitting and/or receiving and/or decoding according to any of the examples described.

A TV, set-top box, cell phone, tablet, or other electronic device may determine the interpolation filter length based on the CU size according to any of the examples described.

A TV, set-top box, cell phone, tablet, or other electronic device may determine the interpolation filter length based on the CU size according to any of the examples described, and display (for example using a monitor, screen, or other type of display) a resulting image.

A TV, set-top box, cell phone, tablet, or other electronic device may select (for example using a tuner) a channel to receive a signal including an encoded image, and determine the interpolation filter length based on the CU size according to any of the examples described.

A TV, set-top box, cell phone, tablet, or other electronic device may receive (for example using an antenna) a signal over the air that includes an encoded image, and determine the interpolation filter length based on the CU size according to any of the examples described.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. An apparatus for video processing, comprising one or more processors, wherein the one or more processors are configured to:
determine an interpolation filter length for an interpolation filter associated with a coding block based on a size of the coding block;
determine an interpolated reference sample based on the determined interpolation filter length for the interpolation filter and based on a motion vector (MV) associated with a reference sample for the coding block; and
predict the coding block based on the interpolated reference sample.

2. The apparatus of claim 1, wherein the one or more processors are further configured to:
select a MV for the coding block from a plurality of MV candidates for the coding block;
determine the MV associated with the reference sample based on the MV for the coding block;
determine the reference sample based on the MV associated with the reference sample; and
perform an interpolation using the reference sample and the interpolation filter to determine the interpolated reference sample.

3. The apparatus of claim 1, wherein the coding block comprises a 4×4 sub-block, and the one or more processors are further configured to determine a MV for the 4×4 sub-block in the coding block, wherein the coding block is predicted, in an affine mode, and using the MV for the 4×4 sub-block and the interpolation filter with the interpolation filter length that is determined based on the size of the coding block.

4. The apparatus of claim 1, wherein the coding block is a first coding block, the size is a first coding block size, the interpolation filter is a first interpolation filter, and the interpolation filter length is a first interpolation filter length, wherein the one or more processors are further configured to determine a second interpolation filter length for a second interpolation filter associated with a second coding block based on a second coding block size of the second coding block, wherein the first coding block size is greater than the second coding block size, and the first interpolation filter length is less than the second interpolation filter length.

5. An apparatus for video processing, comprising one or more processors, wherein the one or more processors are configured to:
determine a size of a coding block and a reference sample for the coding block;
determine whether to apply an interpolation filter on the reference sample for the coding block based on the size of the coding block; and
predict the coding block based on the determination of whether to apply the interpolation filter on the reference sample for the coding block.

6. The apparatus of claim 5, wherein the one or more processors are further configured to:
determine that an interpolation filter length for the interpolation filter is one based on the size of the coding block, wherein the interpolation filter is not applied on the reference sample based on a determination that the interpolation filter length for the interpolation filter is one, and the coding block is predicted using the reference sample for the coding block.

7. The apparatus of claim 5, wherein the one or more processors are further configured to:
determine an interpolation filter length for the interpolation filter associated with the coding block based on the size of the coding block, wherein the interpolation filter length for the interpolation filter is not one; and
determine an interpolated reference sample based on the determined interpolation filter length for the interpolation filter and the reference sample for the coding block, wherein the coding block is predicted based on the interpolated reference sample.

8. A method for video processing, comprising:
determining an interpolation filter length for an interpolation filter associated with a coding block based on a size of the coding block;
determining an interpolated reference sample based on the determined interpolation filter length for the interpolation filter and based on a motion vector (MV) associated with a reference sample for the coding block; and
predicting the coding block based on the interpolated reference sample.

9. The method of claim 8, further comprising:
selecting a MV for the coding block from a plurality of MV candidates for the coding block;
determining the MV associated with the reference sample based on the MV for the coding block;
determining the reference sample based on the MV associated with the reference sample; and
performing an interpolation using the reference sample and the interpolation filter to determine the interpolated reference sample.

10. The method of claim 8, wherein the coding block comprises a 4×4 sub-block, and the method further comprises determining a MV for the 4×4 sub-block in the coding block, wherein the coding block is predicted, in an affine mode, using the MV for the 4×4 sub-block and the interpolation filter with the interpolation filter length that is determined based on the size of the coding block.

11. The method of claim 8, wherein the coding block is a first coding block, the size is a first coding block size, the interpolation filter is a first interpolation filter, and the interpolation filter length is a first interpolation filter length, wherein the method further comprises determining a second interpolation filter length for a second interpolation filter associated with a second coding block that has a second coding block size, wherein the first coding block size is greater than the second coding block size, and the first interpolation filter length is less than the second interpolation filter length.

12. (canceled)

13. (canceled)

14. (canceled)

15. The apparatus of claim 1, wherein, on a condition that the size comprises a first coding block size, the interpolation filter has a first interpolation filter length, and, on a condition that the size comprises a second coding block size, the interpolation filter has a second interpolation filter length, wherein the first coding block size and the second coding block size differ, and the first interpolation filter length and the second interpolation filter length differ.

16. The apparatus of claim 1, wherein the interpolation filter length is indicated by a number of taps for the interpolation filter.

17. The apparatus of claim 1, wherein the reference sample is at an integer position in a reference coding block, and the interpolated reference sample is for a fractional position associated with the reference coding block.

18. The apparatus of claim 1, wherein the interpolation filter comprises an adaptive interpolation filter.

19. The apparatus of claim 1, wherein the interpolation filter length is one, and the interpolated reference sample is the same as the reference sample.

20. The apparatus of claim 1, wherein the apparatus comprises an encoder or a decoder.

21. (canceled)

22. A computer readable medium including instructions for causing one or more processors to perform the method of claim 8.

23. (canceled)

24. (canceled)

25. (canceled)

26. (canceled)

27. (canceled)

28. (canceled)

29. The method of claim 8, wherein, on a condition that the size comprises a first coding block size, the interpolation filter has a first interpolation filter length, and, on a condition that the size comprises a second coding block size, the interpolation filter has a second interpolation filter length, wherein the first coding block size and the second coding block size differ, and the first interpolation filter length and the second interpolation filter length differ.

30. The method of claim 8, wherein the interpolation filter length is indicated by a number of taps for the interpolation filter.
